(19) United States
(12) Patent Application Publication
(10) Pub. No.: US 2021/0073451 A1
(43) Pub. Date: Mar. 11, 2021

(54) EQUIPMENT SELECTION ASSISTANCE APPARATUS AND COMPUTER READABLE MEDIUM

(71) Applicant: MITSUBISHI ELECTRIC CORPORATION, Tokyo (JP)

(72) Inventors: Shinichiro OTANI, Tokyo (JP); Fuyuki SATO, Tokyo (JP); Hiroki KAWANO, Tokyo (JP); Toshihiro MEGA, Tokyo (JP)

(73) Assignee: MITSUBISHI ELECTRIC CORPORATION, Tokyo (JP)

(21) Appl. No.: 17/100,427

(22) Filed: Nov. 20, 2020

Related U.S. Application Data
(63) Continuation of application No. PCT/JP2019/015240, filed on Apr. 8, 2019.

(30) Foreign Application Priority Data
Jul. 11, 2018 (JP) 2018-131373

(51) Int. Cl. G06F 30/33; G06F 1/3206; G06K 9/62

(52) U.S. Cl. CPC G06F 30/33; G06K 9/6268; G06K 9/6218; G06F 1/3206

(57) ABSTRACT

A monitoring system (10) includes an operation record information storage unit (21) to accumulate operation record information about an operating state of equipment (2) collected by an operation record information collection unit (11); an operation model generation unit (12) to generate, for each piece of the equipment, an operation model indicating an operating state of each piece of the equipment (2) based on the operation record information; and an equipment selection processing unit (13) to cause a user interface unit (14) to display operation models, and select the equipment (2) corresponding to an operation model selected by an administrator from the displayed operation models, as control target equipment to be a target of demand control.

### CROSS REFERENCE TO RELATED APPLICATIONS

This application is a Continuation of PCT International Application No. PCT/JP2019/015240, filed on Apr. 8, 2019, which claims priority under 35 U.S.C. 119(a) to Patent Application No. 2018-131373, filed in Japan on Jul. 11, 2018, all of which are hereby expressly incorporated by reference into the present application.

### TECHNICAL FIELD

The present invention relates to an equipment selection assistance apparatus and a program, and in particular relates to assistance in selecting equipment to be a target of demand control.

### BACKGROUND ART

Demand control has conventionally been performed to reduce the peak of power consumption while maintaining as much comfort as possible. In demand control, in order to reduce power consumption in the entirety of a facility, such as a building, it is necessary to select electric equipment in which power usage is to be limited from many pieces of electric equipment installed in the facility. There has been proposed in the past a technique of determining equipment in which power usage is to be limited by predicting power consumption in equipment based on changes in power consumption in a demand time period (for example, Patent Literature 1).

### CITATION LIST

### Patent Literature

Patent Literature 1: JP 2003-319556 A

Patent Literature 2: JP 2007-014179 A

Patent Literature 3: JP 2009-210251 A

Patent Literature 4: JP 2009-240032 A

Patent Literature 5: JP 2011-010497 A

Patent Literature 6: JP 2014-009895 A

Patent Literature 7: JP 2018-014856 A

Patent Literature 8: JP 2018-057165 A

### SUMMARY OF INVENTION

### Technical Problem

It is an object of the present invention to assist selection of equipment to be a target of demand control from pieces of equipment installed in a facility, based on operation records of the pieces of equipment.

### Solution to Problem

An equipment selection assistance apparatus according to the present invention includes an operation record information acquisition means to acquire operation record information indicating an operation record of each piece of equipment installed in a facility; an operation model generation means to generate, for each piece of equipment, an operation model indicating an operating state of each piece of equipment in a predetermined period, based on the operation record information; and a selection processing means to select control target equipment to be a target of demand control from pieces of equipment installed in the facility, based on operation models generated by the operation model generation means.

Further included is a display means to display operation models generated by the operation model generation means, and the selection processing means selects, as the control target equipment, equipment corresponding to an operation model selected by a user from the displayed operation models.

Further included are a cluster model setting means to set, as a cluster model, an operation model corresponding to each cluster generated by classifying operation models generated by the operation model generation means according to similarities into a plurality of clusters; and a display means to display cluster models set by the cluster model setting means, and the selection processing means selects, as the control target equipment, one or more pieces of equipment corresponding to an operation model included in a cluster model selected by the user from the displayed cluster models.

Further included is a selection reference model setting means to set a selection reference model to be compared with each operation model generated by the operation model generation means, and the selection processing means automatically selects the control target equipment, depending on a result of comparison between each operation model generated by the operation model generation means and the selection reference model set by the selection reference model setting means.

As a result of comparison between operation record information before and operation record information after the control target equipment selected by the selection processing means is demand-controlled, when it is determined that a power reduction effect is obtained by selecting the control target equipment as the target of demand control, the selection reference model setting means sets a selection reference model used in selecting the control target equipment as a selection reference model for selecting next control target equipment.

The selection reference model setting means sets, as a selection reference model, a selection reference model used in selecting control target equipment with which a power reduction effect has been obtained in another facility.

Further included is an acceptance means to accept a condition for comparison between an operation model and a selection reference model to be performed by the selection processing means, and the selection processing means selects control target equipment by comparing each operation model with the selection reference model in accordance with the condition for comparison.

Further included is an equipment information acquisition means to acquire equipment information in which pieces of equipment that operate in cooperation are associated with each other, and when a plurality of pieces of control target equipment are selected, the selection processing means refers to the equipment information to identify pieces of equipment respectively associated with the plurality of pieces of control target equipment, assigns priorities to the plurality of pieces of control target equipment based on operation models of the identified pieces of equipment, and narrows down the plurality of pieces of control target equipment according to the priorities.

The selection reference model setting means sets a selection reference model based on a change in the number of occupants in the facility acquired from an entrance and exit management system.

The operation record of each piece of equipment is at least one of an operating time, surplus power, and power consumption.

A program according to the present invention causes a computer to function as an operation record information acquisition means to acquire operation record information indicating an operation record of each piece of equipment installed in a facility; an operation model generation means to generate, for each piece of equipment, an operation model indicating an operating state of each piece of equipment in a predetermined period, based on the operation record information; and a selection processing means to select control target equipment to be a target of demand control from pieces of equipment installed in the facility, based on operation models generated by the operation model generation means.

### Advantageous Effects of Invention

According to the present invention, it is possible to assist selection of equipment to be a target of demand control from pieces of equipment installed in a facility, based on operation records of the pieces of equipment.

### BRIEF DESCRIPTION OF DRAWINGS

FIG. 1 is a block configuration diagram of one embodiment of a monitoring system in a first embodiment;

FIG. 2 is a flowchart illustrating an equipment selection assistance process in the first embodiment;

FIG. 3 is a diagram illustrating an intermediate step in generating an operation model in the first embodiment;

FIG. 4 is a diagram illustrating an example of a generated operation model in the first embodiment;

FIG. 5 is a block configuration diagram illustrating one embodiment of the monitoring system in a second embodiment;

FIG. 6 is a flowchart illustrating an equipment selection assistance process in the second embodiment;

FIG. 7 is a conceptual diagram in which operation models of pieces of equipment are expressed in a graph format in the second embodiment;

FIG. 8 is a conceptual diagram in which operation models in a cluster obtained by clustering operation models are expressed in a graph format in the second embodiment;

FIG. 9 is a conceptual diagram in which operation models in another cluster obtained by clustering operation models are expressed in a graph format in the second embodiment;

FIG. 10 is a block configuration diagram illustrating one embodiment of the monitoring system in a third embodiment;

FIG. 11 is a flowchart illustrating an equipment selection assistance process in the third embodiment;

FIG. 12 is a block configuration diagram illustrating one embodiment of the monitoring system in a fourth embodiment;

FIG. 13 is a diagram for describing a process of setting selection reference models in the fourth embodiment;

FIG. 14 is a block configuration diagram illustrating one embodiment of the monitoring system in a fifth embodiment;

FIG. 15 is a block configuration diagram illustrating one embodiment of the monitoring system in a sixth embodiment;

FIG. 16 is a block configuration diagram illustrating one embodiment of the monitoring system in a seventh embodiment;

FIG. 17 is a block configuration diagram illustrating one embodiment of the monitoring system in an eighth embodiment;

FIG. 18 is a diagram illustrating an example of a selection reference model in the eighth embodiment; and

FIG. 19 is a diagram supplementing a hardware configuration of the monitoring system in a ninth embodiment.

### DESCRIPTION OF EMBODIMENTS

Preferred embodiments of the present invention will be described hereinafter with reference to the drawings.

### First Embodiment

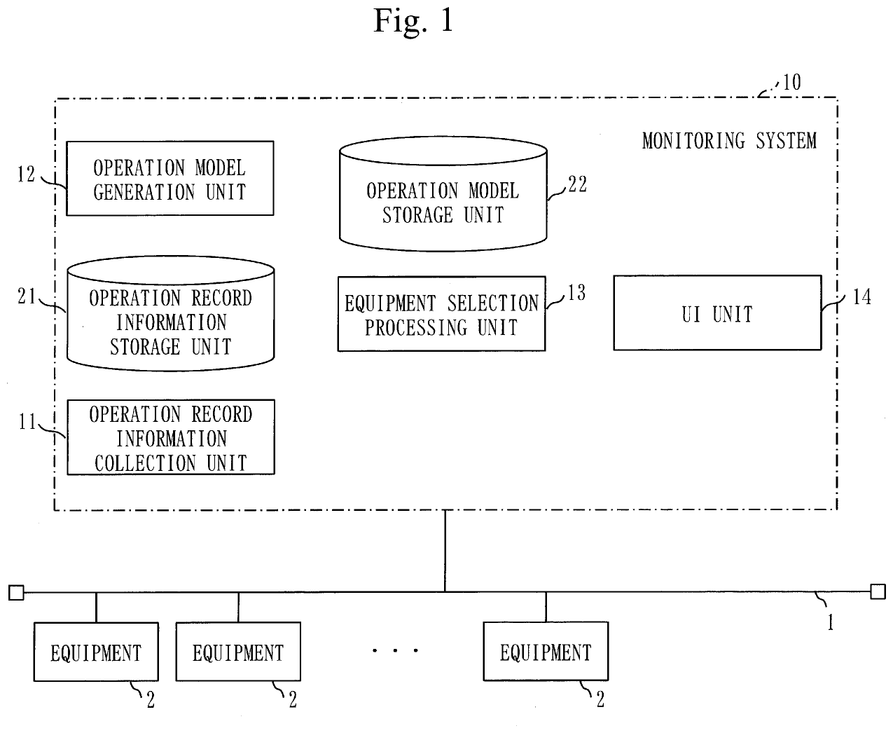

FIG. 1 is a block configuration diagram illustrating one embodiment of a monitoring system in this embodiment. A monitoring system 10 is a system that monitors electrical equipment (hereinafter simply “equipment”) installed in a facility such as a building, and the monitoring system 10 in this embodiment also functions as an equipment selection assistance apparatus according to the present invention. The monitoring system 10 is communicatively connected with each piece of equipment 2 via a network 1. Although the equipment 2 may actually be connected to the network 1 via a controller or the like, this is omitted in FIG. 1 for simplicity of description.

The monitoring system 10 in this embodiment is composed of one or more computers, and each computer can be realized with an existing general-purpose hardware configuration. That is, the computer is configured by connecting, to an internal bus, a CPU, a ROM, a RAM and a hard disk drive (HDD) as storage means, a user interface, and a network interface as a communication means to communicate with the equipment or another computer. The user interface has an input means such as a mouse and a keyboard and a display means such as a display. Alternatively, the user interface may be formed by a touch panel or the like that functions both as the input means and the display means. The hardware configuration in the monitoring system 10 may be substantially the same also in each of the embodiments to be described later.

As illustrated in FIG. 1, the monitoring system 10 in this embodiment has an operation record information collection unit 11, an operation model generation unit 12, an equipment selection processing unit 13, a user interface (UI) unit 14, an operation record information storage unit 21, and an operation model storage unit 22. Components not used in describing this embodiment are omitted from FIG. 1. The same applies to each of the embodiments to be described later.

The operation record information collection unit 11 collects information on an operating state of the equipment 2 (operation record information) and stores it in the operation record information storage unit 21. For example, when the equipment is an air conditioner, information such as a power supply state (ON/OFF), an operating mode, and a set temperature of the air conditioner is collected as operation record information and is stored in association with the date and time of collection. Operation record information is acquired not only from the equipment 2 but also from a sensor that measures a state of the equipment 2 or a state of the installation environment of the equipment 2 or the like, for example, outside air temperature, illuminance, or the like. The operation model generation unit 12 generates, for each piece of the equipment, an operation model indicating the operating state of each piece of the equipment 2 in a predetermined period, based on the operation record information stored in the operation record information storage unit 21, and stores the operation model in the operation model storage unit 22. This embodiment will be described assuming that the predetermined period is the last one month, but the predetermined period is not limited to this and may be one day as in one of the embodiments to be described later.

The equipment selection processing unit 13 selects equipment to be a target of demand control (hereinafter “control target equipment”) from the equipment 2 installed in the facility, based on operation models generated by the operation model generation unit 12. Under control by the equipment selection processing unit 13, the user interface unit 14 accepts information input through a keyboard or the like by a user who decides the control target equipment, and also displays information provided by the monitoring system 10, for example, operation models or the like, on a display.

Each of the components 11 to 14 in the monitoring system 10 is realized by cooperative operation of the computer forming the monitoring system 10 and a program operating on the CPU mounted on the computer. Each of the storage units 21 and 22 is realized by the HDD included in the monitoring system 10. Alternatively, the RAM may be used, or an external storage means may be used via a network.

Programs used in this embodiment can be provided not only via the communication means but can also be stored and provided in a computer-readable recording medium such as a CD-ROM or a USB memory. The programs provided via the communication means or the recording medium are installed in the computer, and the CPU of the computer sequentially executes the programs to realize various processes.

Operation in this embodiment will now be described.

Each piece of the equipment 2 operates in accordance with control by the monitoring system 10. The operation record information collection unit 11 collects a result of the operation, that is, information about the operating state of each piece of the equipment 2 and stores it in the operation record information storage unit 21. The collection and storage of operation record information may be processed in a conventional manner. The above process to acquire operation record information is regularly performed at a predetermined timing separately from an equipment selection assistance process to be described later.

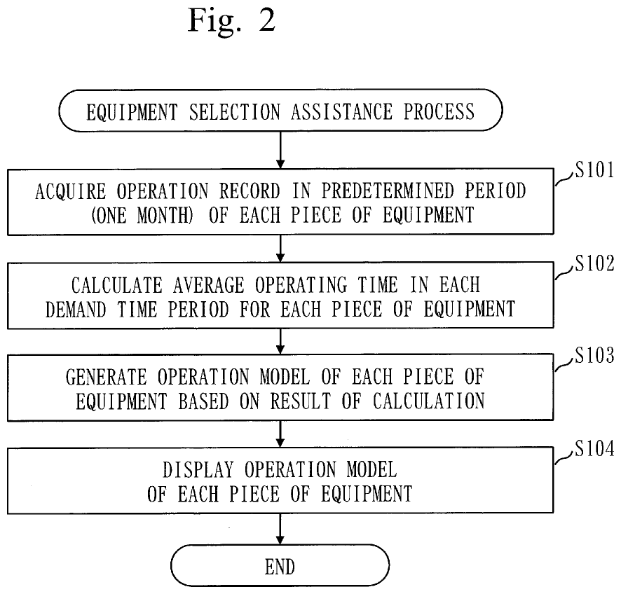

In demand control, if it is predicted that power consumption in a demand time period will exceed contracted power, the operation of one or more pieces of the equipment 2 is limited as necessary so that the contracted power will not be exceeded. To do so, a user who manages the equipment 2 in demand control such as a building administrator (hereinafter referred to as “administrator”) selects the control target equipment from the equipment 2 installed in the building. This embodiment is characterized in that information for assisting the selection of the control target equipment is provided to the administrator. The equipment selection assistance process in this embodiment will be described below using a flowchart illustrated in FIG. 2.

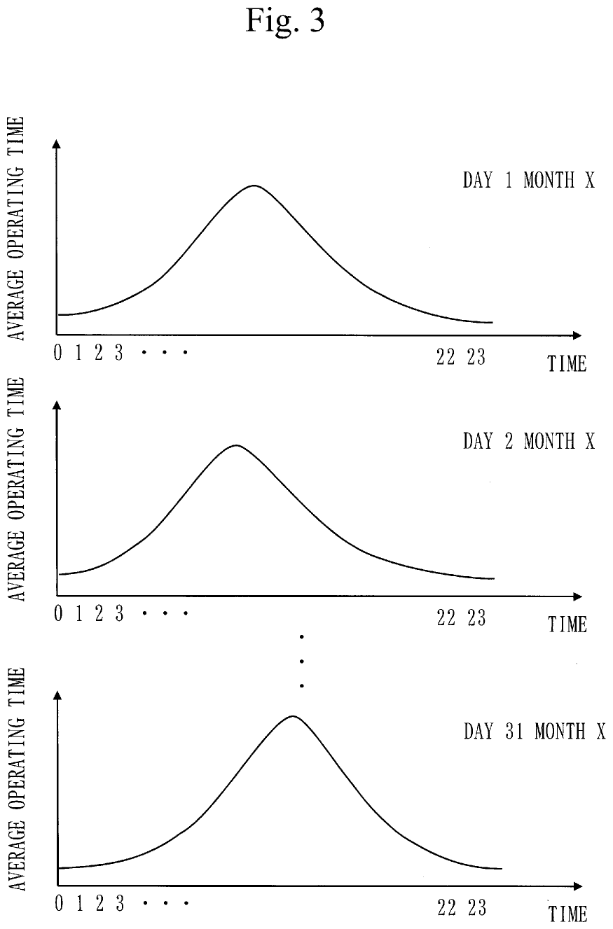

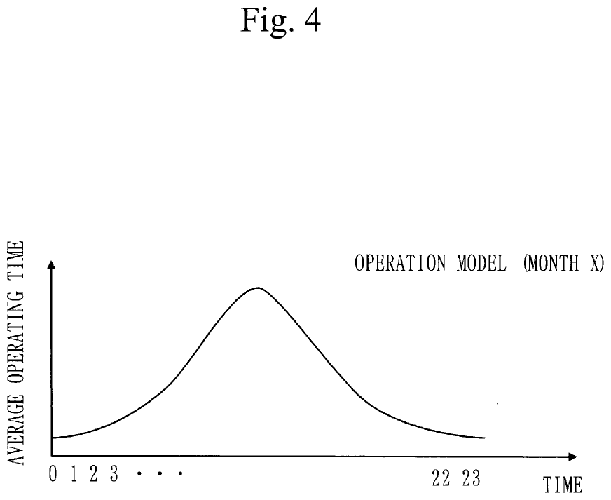

The operation model generation unit 12 retrieves and acquires operation record information in the predetermined period (one month in this embodiment) of each piece of the equipment 2 from the operation record information storage unit 21 (step 101). Operating times are acquired as the operation record information here. Then, the average value of the operating time in each demand time period on each day is calculated for each piece of the equipment 2 (step 102). In FIG. 3, changes in the average operating time of a certain piece of the equipment 2 on each day in a certain month (month X) are indicated in a graph format. The operation model generation unit 12 further calculates the average value of the average operating time in each demand time period, so as to obtain the average operating time in each demand time period in the month concerned. In this way, the operation model generation unit 12 generates the average operating time obtained based on the operation record information (operating times in this case) of the equipment 2, as an operation model (step S103). FIG. 4 illustrates the operation model expressed in a graph format. The operation model generation unit 12 generates the operation model of each piece of the equipment 2 as described above, and stores it in the operation model storage unit 22.

After the operation model of each piece of the equipment 2 is generated, the equipment selection processing unit 13 displays the operation model on the user interface unit 14 in response to an operation of the administrator (step 104). How to prompt the administrator to specify the operation model to be displayed and the display form of the operation model are not particularly limited. For example, the operation model is displayed as described below.

Each operation model is registered in the operation model storage unit 22 in association with information on a corresponding piece of the equipment 2, such as an equipment name, an installation location, and a model, for example, and the equipment selection processing unit 13 displays the information on the equipment 2 on an operation model selection screen (not illustrated). Then, when the administrator selects the information on the equipment 2 to be displayed, the equipment selection processing unit 13 searches for the operation model storage unit 22 using the information on the equipment 2 selected by the administrator as a search condition, and thereby retrieves a relevant operation model from the operation model storage unit 22. In this way, the operation model is displayed on the user interface unit 14.

With an operation model generated based on the operating time, it is usually considered that the longer the average operating time, the larger the power consumption relatively, although it depends on the model. Therefore, it is preferable for the administrator to refer to time-series changes in the operation models (changes in the average operating times) and select the equipment 2 with a relatively long average operating time from the equipment 2 corresponding to the displayed operation models. In this way, the equipment selection processing unit 13 obtains the equipment 2 corresponding to one or more operation models selected by the administrator, as the control target equipment.

As described above, according to this embodiment, the selection of the control target equipment from the equipment 2 installed in a building can be assisted by generating and displaying the operation model of each piece of the equipment 2. This allows the administrator to select the control target equipment that is more appropriate, that is, the equipment 2 in which the power reduction effect can be expected, in comparison to a case in which the administrator seeks out the control target equipment from many pieces of the equipment 2.

It is assumed in this embodiment that the predetermined period is one month and the period for which the average operating time is to be calculated within the predetermined period is the demand time period. However, there is no need to limit these periods to these examples.

This embodiment has been described using as an example the case in which operating times are used as the operation record information to be used in generating operation models. However, operating times are an example and the operation record information does not have to be limited to this.

For example, power consumption may be used. Alternatively, surplus power of the equipment 2, which indicates power consumption that can be reduced by control, may be used. When the equipment 2 is lighting, dimming levels may be used. When the equipment 2 is an air conditioner, a difference between an outside air temperature and a set temperature may be used. It is predicted that the larger the difference, the more powerful the operation, that is, the operation is performed with greater power consumption. Alternatively, the number of revolutions of a compressor and the operating mode, such as heating, cooling, and ventilation, may be referred to. The form of an operation model changes depending on an index used to generate the operation model. That the greater the value of the index, the greater the power consumption as in the case of the operating time may not apply to all types of indices. These indices are not limited to being used individually, but a plurality of indices may be obtained and combined to generate an operation model.

### Second Embodiment

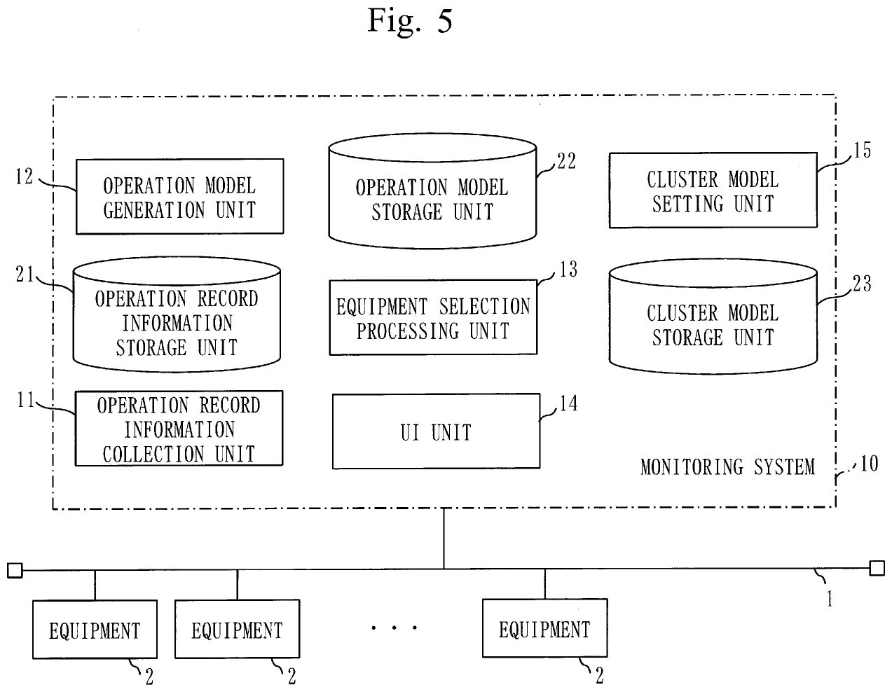

FIG. 5 is a block configuration diagram of a monitoring system in this embodiment. The components that are the same as those in the first embodiment are denoted by the same reference signs and description thereof will be omitted.

The monitoring system 10 in this embodiment has a cluster model setting unit 15 and a cluster model storage unit 23 in addition to the components indicated in the first embodiment. The cluster model setting unit 15 is provided as a representative operation model setting means, and classifies (clusters) operation models of pieces of the equipment 2 into groups, and for each classified cluster, sets a representative operation model representing operation models belonging to the cluster concerned. In this embodiment, the representative operation model will be referred to as a “cluster model”. The cluster model storage unit 23 stores cluster models set by the cluster model setting unit 15. The cluster model setting unit 15 is realized by cooperative operation of the computer forming the monitoring system 10 and a program operating on the CPU mounted on the computer. The cluster model storage unit 23 is realized by the HDD included in the monitoring system 10. Alternatively, the RAM may be used, or an external storage means may be used via the network.

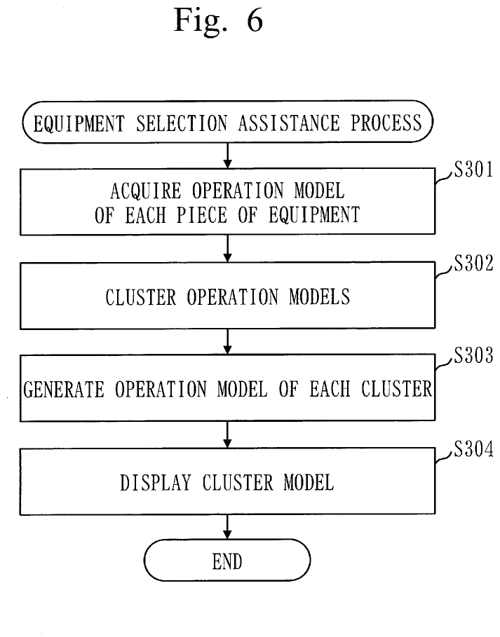

An equipment selection assistance process in this embodiment will now be described using a flowchart illustrated in FIG. 6. The process up to generation of operation models (steps 101 to 103 in FIG. 2) may be the same as in the first embodiment, so that this embodiment will be described assuming that operation models have already been generated.

The cluster model setting unit 15 retrieves and acquires all the operation models from the operation model storage unit 22 (step 301). Then, the cluster model setting unit 15 extracts features from each of the operation models and clusters the operation models according to similarities of the features (step 302). An existing technique may be used for extracting features and clustering.

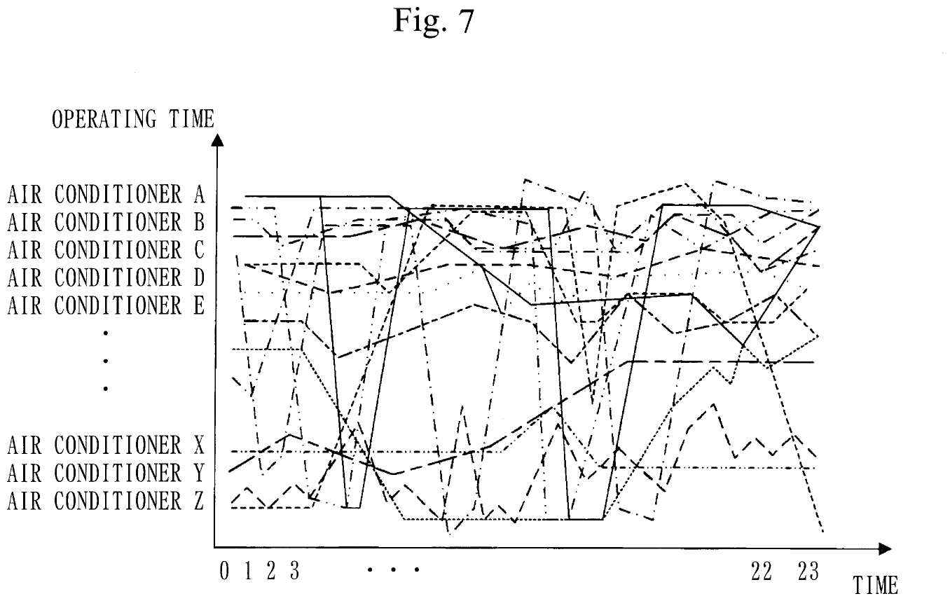

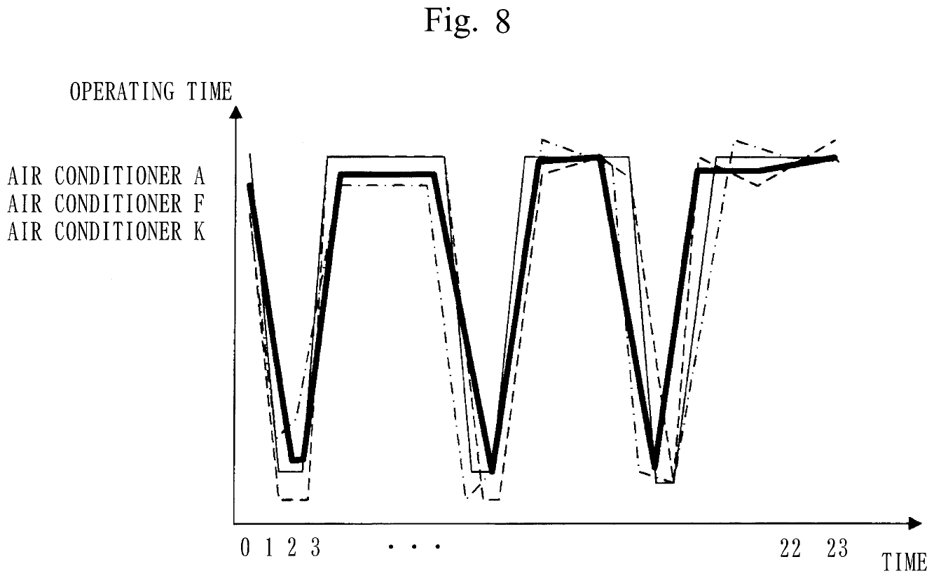

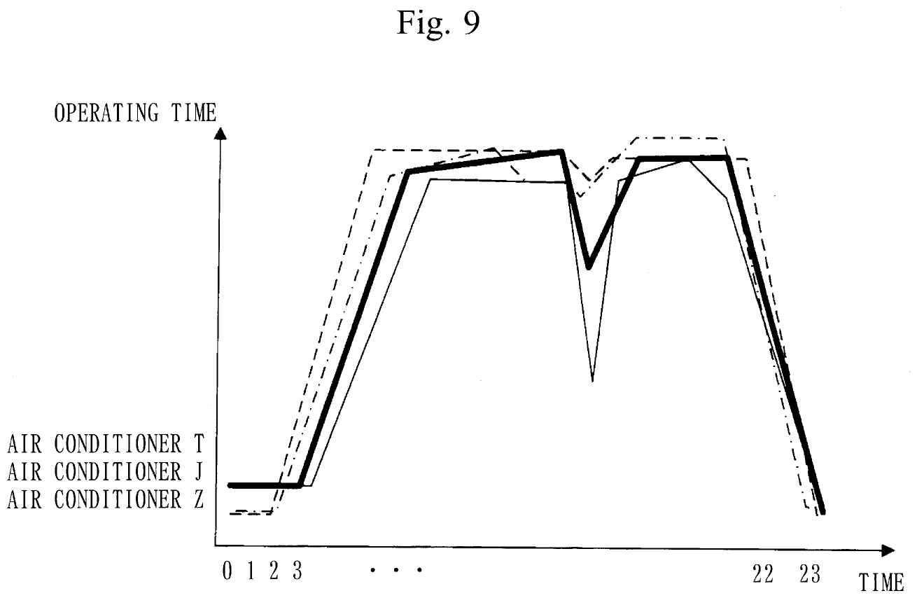

FIG. 7 is a conceptual diagram in which the operation models retrieved from the operation model storage unit 22 are expressed in a graph format on the same coordinate system. FIGS. 8 and 9 are conceptual diagrams in which operation models in each cluster (group) obtained as a result of clustering based on the features of each operation model are expressed in a graph format on the same coordinate system. In this embodiment, only two clusters are illustrated, but the number of clusters to be created is not limited to this. In FIGS. 7 to 9, the equipment 2 is assumed to be an air conditioner. FIGS. 8 and 9 are conceptual diagrams for describing generation of clusters by extracting air conditioners with high similarities from the air conditioners whose operation models are illustrated in FIG. 7, and the indices of the operation models themselves and indicated values have no special meanings.

After classifying every one of the operation models into one of the clusters, the cluster model setting unit 15 generates a cluster model for each cluster (step 303). The cluster model may be generated, for example, by calculating the average value or median value of operation models, or one of operation models representing the characteristics of the cluster may be adopted as the cluster model. In each of FIGS. 8 and 9, the cluster model is indicated by a thick line. The cluster model setting unit 15 generates a cluster model for each cluster as described above, and stores it in the cluster model storage unit 23. With each cluster model, information that identifies each operation model used to generate the cluster model concerned or the equipment 2 corresponding to each operation model concerned is associated.

After the cluster models are generated as described above, the equipment selection processing unit 13 causes the user interface unit 14 to display one of the cluster models in response to an operation of the administrator (step 304). How to prompt the administrator to specify the operation model to be displayed is not particularly limited. The administrator refers to a cluster model selection screen (not illustrated) and selects one of the cluster models on the screen. More than one cluster model may be selected.

After the cluster model is selected by the administrator, the equipment selection processing unit 13 identifies the operation models used to generate the selected cluster model, and obtains the equipment 2 corresponding to the identified operation models as the control target equipment.

The first embodiment above requires the administrator to select operation models one by one, whereas this embodiment allows pieces of the equipment 2 corresponding to a cluster to be collectively selected. That is, if one operation model is selected by the administrator in the first embodiment, it can be expected that an operation model having a graph shape similar to that of the selected operation model (operation model in which the index value changes similarly) will be selected for the same reason. In the first embodiment, the administrator needs to refer to the operation models and select the control target equipment one by one. In this embodiment, clustering is performed based on the features of the operation models, so that the administrator can collectively select operation models that indicate similar changes.

In this embodiment, pieces of the control target equipment can be collectively selected. The equipment selection processing unit 13 may be provided with a function to allow the administrator to exclude a piece of the control target equipment that is not needed from the selected pieces of the control target equipment.

### Third Embodiment

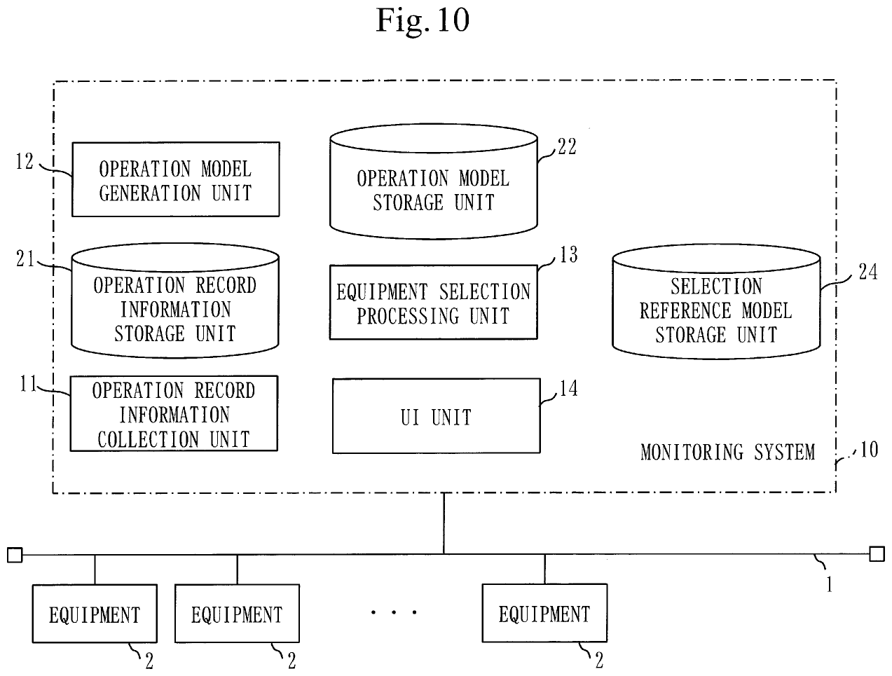

FIG. 10 is a block configuration diagram of a monitoring system in this embodiment. The components that are the same as those in the first embodiment are denoted by the same reference signs and description thereof will be omitted.

The monitoring system 10 in this embodiment has a selection reference model storage unit 24 in addition to the components indicated in the first embodiment. The selection reference model storage unit 24 stores selection reference models to be compared with each operation model generated by the operation model generation unit 12. The selection reference model storage unit 24 is realized by the HDD included in the monitoring system 10. Alternatively, the RAM may be used, or an external storage means may be used via the network.

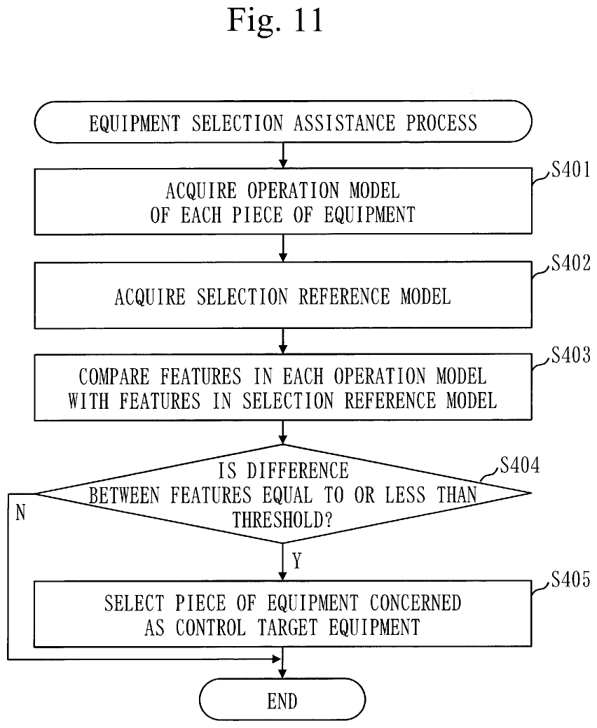

An equipment selection assistance process in this embodiment will now be described using a flowchart illustrated in FIG. 11. The process up to generation of operation models (steps 101 to 103 in FIG. 2) may be the same as in the first embodiment, so that description thereof will be omitted. In this embodiment, the process after the operation models have been generated will be described.

The equipment selection processing unit 13 retrieves and acquires all the operation models from the operation model storage unit 22 (step 401), and retrieves and acquires a selection reference model from the selection reference model storage unit 24 (step 402). Then, the equipment selection processing unit 13 compares features in each of the acquired operation models with features in the selection reference model (step 403), and selects the control target equipment depending on the result of comparing the features. That is, in this embodiment, if a difference in the features is equal to or less than a predetermined threshold (Y in step 404), it is determined that the operation model concerned resembles the selection reference model and the equipment 2 corresponding to the operation model concerned is selected as the control target equipment. If the difference in the features exceeds the predetermined threshold (N in step 404), the operation model does not resemble the selection reference model, so that the equipment 2 corresponding to the operation model concerned is not selected as the control target equipment.

In the first and second embodiments, operation models or cluster models are presented to the administrator to prompt the administrator to select the operation model, that is, the equipment 2 to be the control target equipment. In this embodiment, a typical operation model to be preferably selected as the control target equipment is prepared in advance as a selection reference model, and an operation model that resembles the selection reference model is extracted, thereby allowing the equipment selection processing unit 13 itself to automatically select the control target equipment.

In this embodiment, the equipment 2 corresponding to an operation model resembling the selection reference model is selected as the control target equipment. Conversely, the equipment 2 corresponding to an operation model resembling the selection reference model among the equipment 2 may be excluded from the control target equipment. The same applies to the embodiments to be described later in which selection reference models are used.

### Fourth Embodiment

In the third embodiment above, the control target equipment can be selected using the selection reference model prepared in advance. However, how to set the selection reference model has not been mentioned. The embodiments to be described hereinafter concern the setting of selection reference models.

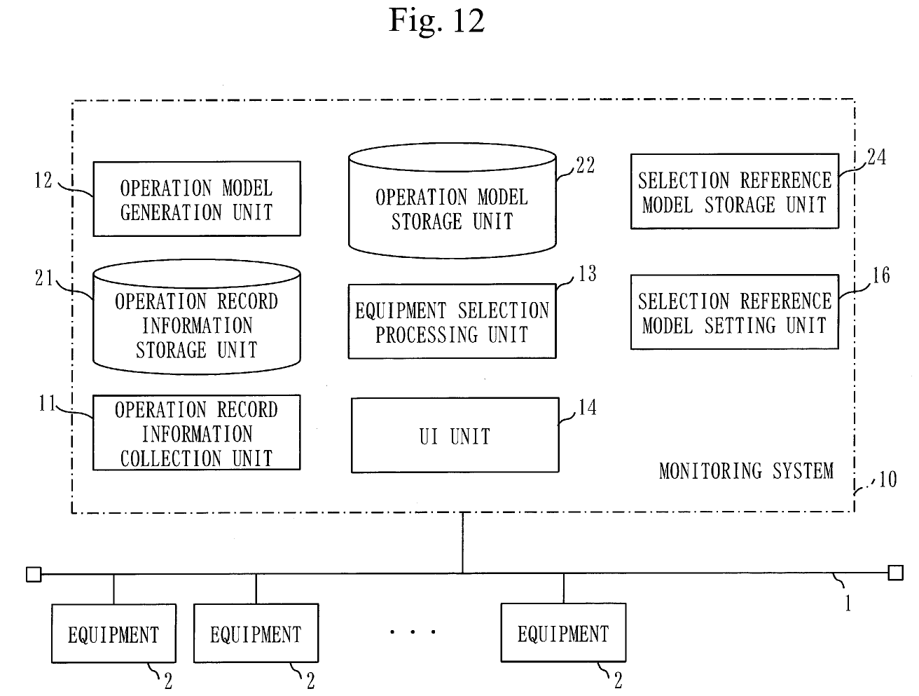

FIG. 12 is a block configuration diagram of a monitoring system in this embodiment. The components that are the same as those in the third embodiment are denoted by the same reference signs and description thereof will be omitted.

The monitoring system 10 in this embodiment has a selection reference model setting unit 16 in addition to the components described in the third embodiment. The selection reference model setting unit 16 sets the selection reference model to be compared with each operation model generated by the operation model generation unit 12. The selection reference model setting unit 16 is realized by cooperative operation of the computer forming the monitoring system 10 and a program operating on the CPU included in the computer.

As described above, the control target equipment selected in each of the above embodiments is demand-controlled. Then, the operating states under demand control are collected as operation record information and are accumulated in the operation record information storage unit 21.

The operating states of the control target equipment before being demand-controlled are also accumulated in the operation record information storage unit 21. Therefore, by comparing operation record information before demand control is applied (operation without being demand-controlled) with operation record information after demand control is applied (operation while being demand-controlled), the appropriateness of selection of the control target equipment as the target of demand control can be determined. For example, if the power reduction amount in the control target equipment when selected as the target of demand control exceeds a predetermined threshold, the power reduction effect of the equipment 2 is relatively high, so that it can be concluded that the selection of the equipment 2 concerned as the control target equipment is appropriate. If the power reduction amount in the control target equipment when selected as the target of demand control is equal to or less than the predetermined threshold, the power reduction effect of the equipment 2 is relatively low, so that there may be doubt about selecting the equipment 2 as the control target equipment. Therefore, in this embodiment, a selection reference model to be used in selecting the next control target equipment is set depending on the result of comparing operation record information before demand control is applied with operation record information after demand control is applied.

That is, as a result of comparing the operation record information before demand control is applied with the operation record information after demand control is applied with regard to the control target equipment selected most recently by the equipment selection processing unit 13, if it is determined that the power reduction amount achieved by setting the control target equipment concerned as the target of demand control exceeds the predetermined threshold and thus the desired power reduction effect has been achieved, the selection reference model setting unit 16 sets the selection reference model used to select the control target equipment concerned as the selection reference model for selecting the next control target equipment, and stores that selection reference model in the selection reference model storage unit 24. The subsequent equipment selection process using the selection reference model may be the same as in the third embodiment, and thus description thereof will be omitted. If the power reduction amount is equal to or less than the predetermined threshold and thus an expected level of the power reduction effect has not been achieved, the selection reference model used to select the control target equipment concerned is not used as the selection reference model for selecting the next control target equipment.

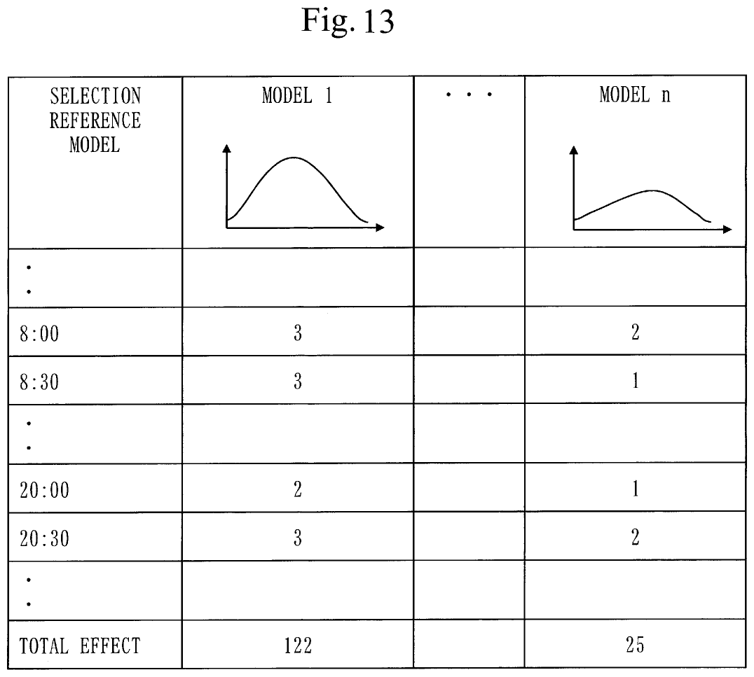

FIG. 13 is a diagram for describing details of the process in this embodiment. FIG. 13 indicates scoring results when the power reduction effect in each demand time period is evaluated in three levels for each of selection reference models 1 to n used in selecting the control target equipment most recently. In FIG. 13, the highest level of evaluation of the power reduction effect is 3, the lowest level of evaluation is 1, and the intermediate level between them is 2. Each evaluation is determined by comparing the power reduction amount with a predetermined threshold. The predetermined period used in generating the operation models indicated in FIG. 13 is one day.

As indicated in FIG. 13, for each of the selection reference models, the selection reference model setting unit 16 evaluates the power reduction effect in each demand time period, and sums the evaluation values to evaluate the power reduction effect (total effect in FIG. 13) in each of the selection reference models. Then, a selection reference model whose total effect exceeds the predetermined threshold is extracted as the selection reference model for selecting the next control target equipment.

Although it may depend on the type of the equipment 2, for the equipment 2 that is affected by the seasons, such as outside temperature and daylight hours, it is preferable that operation record information while being demand-controlled and operation record information before being demand-controlled with regard to the control target equipment be collected in similar operating environments.

According to this embodiment, the power reduction effect can be further enhanced by re-using a selection reference model with which the power reduction effect has been actually obtained.

In this embodiment, the power reduction amount is used to determine the power reduction effect as an example, but this is not limiting and other indices, for example, a power reduction rate or the like, may be used, depending on the scale and characteristics of the equipment 2.

### Fifth Embodiment

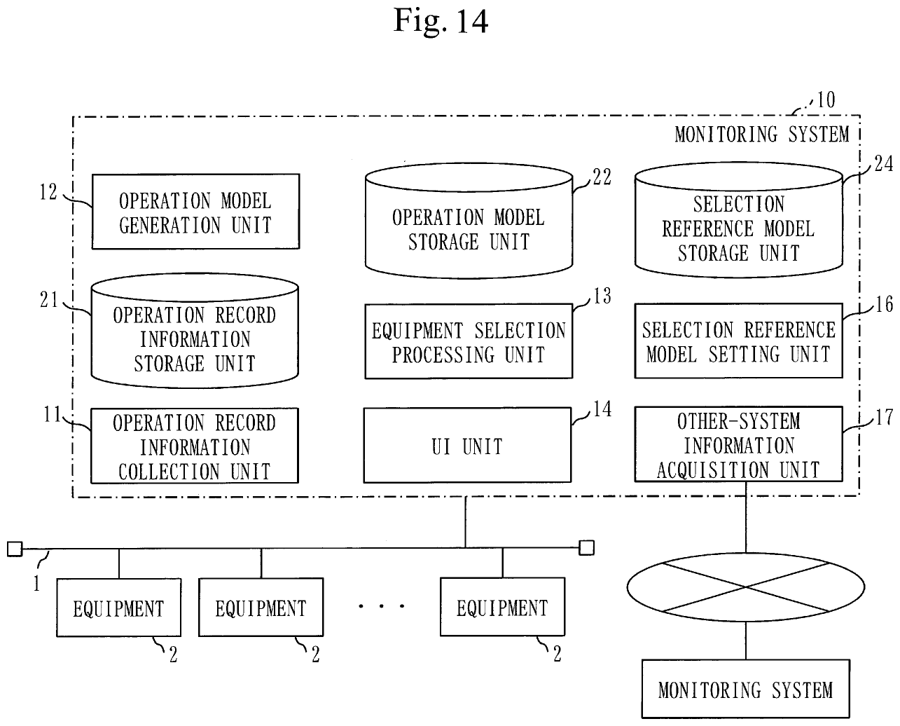

FIG. 14 is a block configuration diagram of a monitoring system in this embodiment. The components that are the same as those in the third embodiment are denoted by the same reference signs and description thereof will be omitted.

The monitoring system 10 in this embodiment has the selection reference model setting unit 16 and an other-system information acquisition unit 17 in addition to the components indicated in the third embodiment. The other-system information acquisition unit 17 acquires information that can be used to set a selection reference model from another monitoring system, as will be described in detail later. The selection reference model setting unit 16 sets a selection reference model as in the fourth embodiment, and in this embodiment, sets a selection reference model by referring to the information acquired by the other-system information acquisition unit 17. The selection reference model setting unit 16 and the other-system information acquisition unit 17 are realized by cooperative operation of the computer forming the monitoring system 10 and programs operating on the CPU mounted on the computer.

In the first to third embodiments above, actual results (power reduction effect) in the selected control target equipment are not verified. That is, the control target equipment is demand-controlled in a situation in which the power reduction effect has not been verified. In the fourth embodiment, a selection reference model is set by comparing the operation record information before demand control is applied to the control target equipment with the operation record information after demand control is applied to the control target equipment (while being demand-controlled), so that a certain level of the power reduction effect is guaranteed. However, the power reduction effect cannot be verified unless operation control with demand control being applied is performed.

Therefore, this embodiment is characterized in that information of another monitoring system is effectively used.

That is, as described in the fourth embodiment, actual results are guaranteed for a selection reference model that is set by comparing operation record information before demand control is applied with operation record information after demand control is applied. When another monitoring system has set a selection reference model by the method of the fourth embodiment, actual results are guaranteed for the selection reference model in the other monitoring system. Therefore, in this embodiment, the other-system information acquisition unit 17 is made to work in cooperation with another monitoring system, and the other-system information acquisition unit 17 is made to acquire a selection reference model obtained by the other monitoring system. This allows the selection reference model setting unit 16 to set a selection reference model for which actual results are guaranteed without waiting for the collection of operation record information after demand control is applied.

In this way, the selection reference model setting unit 16 sets the selection reference model acquired by the other-system information acquisition unit 17 as a selection reference model in its own system, and stores that selection reference model in the selection reference model storage unit 24. The subsequent equipment selection process using the selection reference model may be the same as in the third embodiment, and thus description thereof will be omitted.

According to this embodiment, a selection reference model that has been successfully used in another monitoring system can be effectively used.

It is preferable for the other-system information acquisition unit 17 to acquire a selection reference model from another monitoring system whose monitoring target is a facility where a scale, a type of equipment, the number of pieces of equipment, and the like are similar to those of the facility that is the monitoring target of its own system.

### Sixth Embodiment

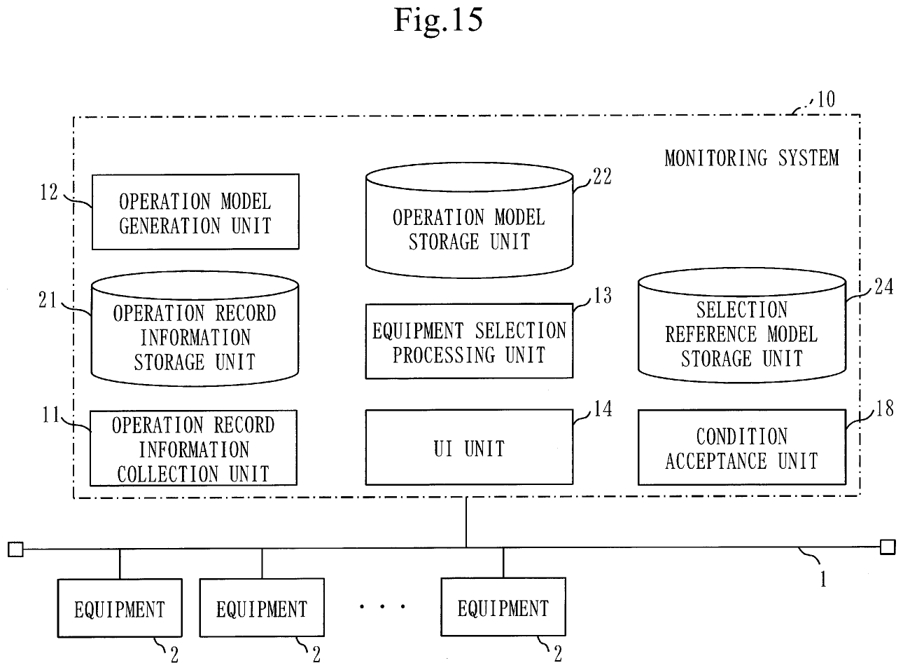

FIG. 15 is a block configuration diagram of a monitoring system in this embodiment. The components that are the same as those in the third embodiment are denoted by the same reference signs and description thereof will be omitted.

The monitoring system 10 in this embodiment has a condition acceptance unit 18 in addition to the components indicated in the third embodiment. The equipment selection processing unit 13 in each of the above embodiments compares each operation model with the selection reference model. At that time, since no particular conditions for comparison are specified, the entire operation model, of the entire month according to the operation model illustrated in FIG. 4, is compared with the entire selection reference model. In contrast, the equipment selection processing unit 13 in this embodiment compares each operation model with the selection reference model as in each of the above embodiments, but compares each operation model with the selection reference model in accordance with a condition for comparison accepted by the condition acceptance unit 18. The condition acceptance unit 18 thus accepts the condition for comparison between each operation model and the selection reference model to be performed by the equipment selection processing unit 13. The condition for comparison is specified by the administrator. The condition acceptance unit 18 is realized by cooperative operation of the computer forming the monitoring system 10 and a program operating on the CPU mounted on the computer.

As described above, in each of the embodiments above, the entire operation model is compared with the entire selection reference model. However, for example, when the operation model is generated for one day instead of one month, attention may be focused on only a partial range, instead of the entirety, of the operation model, such as the equipment 2 in which the operation start (activation start) time is between 8:00 and 8:30 or the equipment 2 in which the maximum value of the index value is equal to or more than a predetermined value. In this case, if the equipment 2 is not activated between 8:00 and 8:30, the equipment selection processing unit 13 does not select the equipment 2 concerned as the control target equipment even when the operation model as a whole resembles the selection reference model. Similarly, if the maximum value of the index value is less than the predetermined value, the equipment selection processing unit 13 does not select the equipment 2 concerned as the control target equipment even when the operation model as a whole resembles the selection reference model.

The condition for comparison between the operation model and the selection reference model described above may be described as a condition for selection as the control target equipment. The condition acceptance unit 18 may accept a plurality of conditions as conditions for comparison (conditions for selection). The equipment selection processing unit 13 may select the control target equipment by narrowing down pieces of the equipment 2 whose operation models resemble the selection reference model as a whole to pieces of the equipment 2 that match the condition for comparison. Alternatively, if the operation model matches the condition for comparison, the equipment 2 corresponding to the operation model concerned may be selected as the control target equipment even when the operation model as a whole does not resemble the selection reference model.

For example, when the equipment 2 that is activated between 8:00 and 8:30 is selected, the administrator can change an activation schedule so that the power load required for activating the equipment 2 can be smoothed by advancing the activation start time of the equipment 2 concerned to between 7:30 and 8:00.

This embodiment has been described using as an example the case in which a part of an existing selection reference model is used as a range to be compared with an operation model. Alternatively, a selection reference model setting unit may be provided to generate a partial selection reference model instead of a selection reference model covering the entirety (one day), for example, a selection reference model of only between 8:00 and 8:30, a selection reference model indicating the maximum value of the index value, or the like, and the equipment selection processing unit 13 may compare each operation model with the selection reference model generated by the selection reference model setting unit.

### Seventh Embodiment

In many cases, pieces of the equipment 2 having similar specifications are installed in a facility, such as installing the equipment 2 of the same model on each floor. In the third to sixth embodiments above, each operation model is compared with the selection reference model to automatically select the control target equipment. It is possible to envisage a case in which since similar operation models are generated for pieces of the equipment 2 having similar specifications, these pieces of the equipment 2 are selected as the control target equipment together by comparison with the selection reference model. Pieces of the equipment 2 having similar specifications may certainly be set as the target of demand control, but setting many pieces of the control target equipment as the target of demand control together will reduce power consumption more than is necessary. Although it is desirable to reduce power consumption, the comfort of users of the facility may be diminished more than is necessary.

Therefore, this embodiment is characterized in that when, for example, many pieces of the control target equipment are selected, the selected pieces of the control target equipment can be narrowed down.

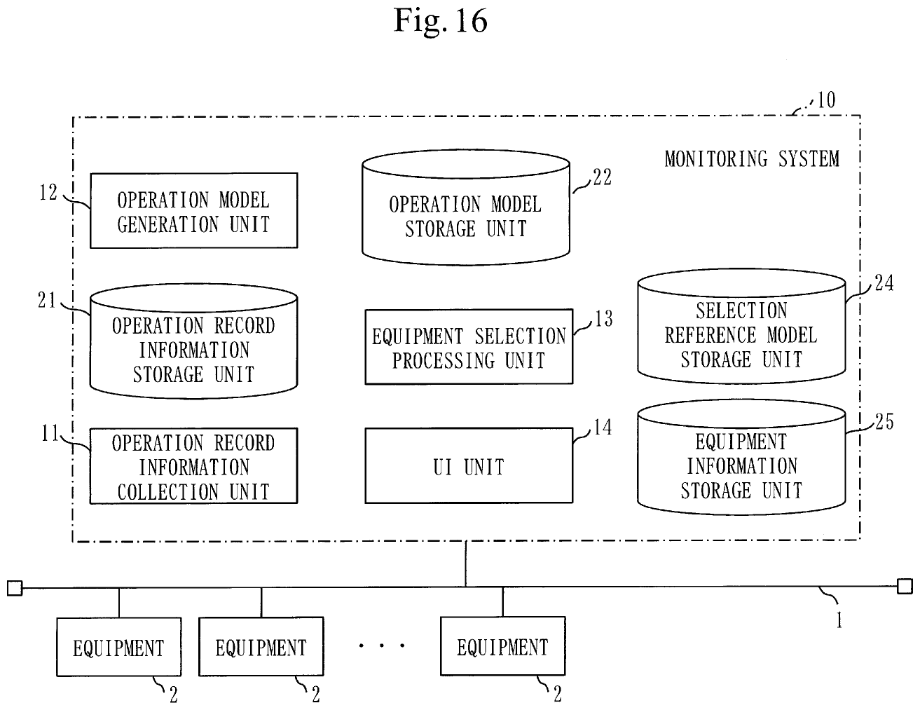

FIG. 16 is a block configuration diagram of a monitoring system in this embodiment. The components that are the same as those in the third embodiment are denoted by the same reference signs and description thereof will be omitted.

The monitoring system 10 in this embodiment has an equipment information storage unit 25 in addition to the components indicated in the third embodiment. The equipment information storage unit 25 stores equipment information in which the equipment 2 and equipment that operate in cooperation are associated with each other. For example, in the case of an air conditioner, power consumption changes depending on the state of an attached thermo-controller. In this way, equipment information is set in advance by associating the equipment 2 with certain equipment 2 when the equipment 2 consumes power depending on the operation of the certain equipment 2, and registers it in the equipment information storage unit 25. It is not necessary to set equipment information for all pieces of the equipment 2.

For example, assume that the equipment selection processing unit 13 has automatically selected many pieces of the equipment 2 the number of which is equal to or more than a predetermined threshold as the control target equipment. In this case, if all the selected pieces of the target equipment become the target of demand control, it can be envisaged that power consumption will be reduced more than is necessary and comfort will be diminished. Thus, the selected pieces of control target equipment need to be narrowed down.

Therefore, when the number of selected pieces of the control target equipment is equal to or more than the predetermined threshold, the equipment selection processing unit 13 in this embodiment refers to equipment information of each piece of the control target equipment to identify the equipment 2 associated with the control target equipment concerned (hereinafter “related equipment”), and retrieves the operation model of the identified related equipment from the operation model storage unit 22. For example, operation models indicating the average operating time are retrieved. If operation models based on a predetermined index (average operating time in the above example) have not been generated, the operation model generation unit 12 may be caused to generate them. Then, the equipment selection processing unit 13 causes the user interface unit 14 to display the retrieved operation models. The administrator refers to the displayed operation models, and prioritizes the pieces of the control target equipment associated with the pieces of the related equipment corresponding to the operation models. The equipment selection processing unit 13 accepts the priorities of the pieces of the control target equipment assigned by the administrator.

Then, upon accepting the number of pieces of equipment n specified by the administrator, for example, the equipment selection processing unit 13 extracts pieces of the control target equipment having the first to n-th highest priorities. In this way, the equipment selection processing unit 13 narrows down the selected pieces of the control target equipment according to the priorities.

According to this embodiment, pieces of the control target equipment can be prioritized and narrowed down using the operation models of another piece of equipment (thermo-controller in the above example).

In the above example, the average operating time is used as an index value used for calculating the operation model of the related equipment, as an example, but this is not limiting and power consumption, surplus power, or the like indicated as examples in the first embodiment may be used. Alternatively, weather information/weather forecast, room temperature/suction temperature, the operating time of equipment 2 in the same room as the air conditioner (equipment 2), the number of occupants, the operating state (operating mode), and the like may be used.

In this embodiment, priorities are assigned by the administrator. However, priorities may be automatically assigned, for example, in descending order of the index value (average value, maximum value, mean value, etc.) indicated in the related equipment.

### Eighth Embodiment

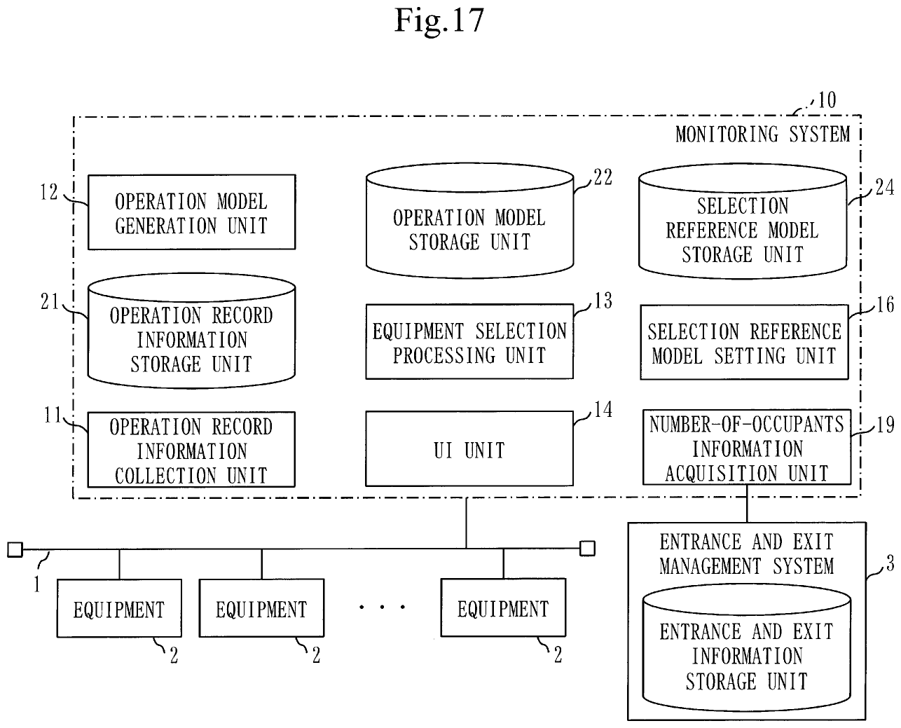

FIG. 17 is a block configuration diagram of a monitoring system in this embodiment. The components that are the same as those in the third embodiment are denoted by the same reference signs and description thereof will be omitted.

The monitoring system 10 in this embodiment has the selection reference model setting unit 16 and a number-of-occupants information acquisition unit 19 in addition to the components described in the third embodiment. The number-of-occupants information acquisition unit 19 acquires information on the number of occupants from an entrance and exit management system 3, as will be described in detail later. The selection reference model setting unit 16 sets a selection reference model as in the fourth embodiment, and in this embodiment, sets a selection reference model based on changes in the number of occupants in the facility acquired by the number-of-occupants information acquisition unit 19 from the entrance and exit management system 3. The selection reference model setting unit 16 and the other-system information acquisition unit 17 are realized by cooperative operation of the computer forming the monitoring system 10 and programs operating on the CPU mounted on the computer.

The equipment 2 includes the equipment 2 in which power consumption depends on the number of occupants in a room in the facility, such as air conditioners and lighting, for example. The room temperature tends to rise when there are a large number of occupants, so that in summer the set temperature is lowered and power consumption increases accordingly. Lighting is turned off when there are no occupants. Lighting in only a portion of the room may be turned on when there are a small number of occupants and the locations of the occupants are not distributed evenly.

There is thus the equipment 2 whose power consumption depends on the number of occupants. In this embodiment, therefore, a selection reference model is set based on the number of occupants.

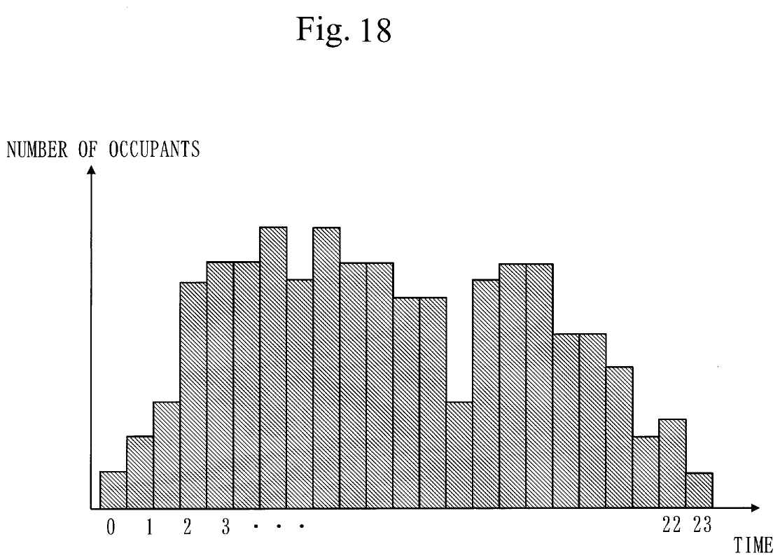

Thus, the number-of-occupants information acquisition unit 19 acquires information on the number of occupants indicating changes in the number of occupants in a predetermined period from the entrance and exit management system 3. Then, the selection reference model setting unit 16 sets a selection reference model based on the acquired information on the number of occupants. FIG. 18 illustrates an example of a selection reference model in this embodiment. In FIG. 18, the selection reference model is indicated in a bar graph format, but it may be expressed by a curved line to correspond to operation models. Then, the equipment selection processing unit 13 compares each operation model with the selection reference model to automatically select the equipment 2 corresponding to an operation model resembling the selection reference model as the control target equipment. Since the selection reference model is to be compared with operation models, it is preferable for the predetermined period for which information on the number of occupants is acquired from the entrance and exit management system 3 to be the same as the period for generating operation models.

As described above, according to this embodiment, the selection reference model can be set in cooperation with the entrance and exit management system 3.

In each of the above embodiments, the monitoring system 10 has the functions as the equipment selection assistance apparatus. However, the equipment selection assistance apparatus may be formed separately from the monitoring system 10. In that case, the operation record information and so on held by the monitoring system 10 need to be acquired from the monitoring system 10.

### Ninth Embodiment

In a ninth embodiment, the hardware configuration of the monitoring system 10 in each of the first to eighth embodiments will be supplemented.

The functions of the equipment selection assistance apparatus, which is the monitoring system 10, described in the first to eighth embodiments are realized by programs. However, the functions of the equipment selection assistance apparatus may be realized by hardware.

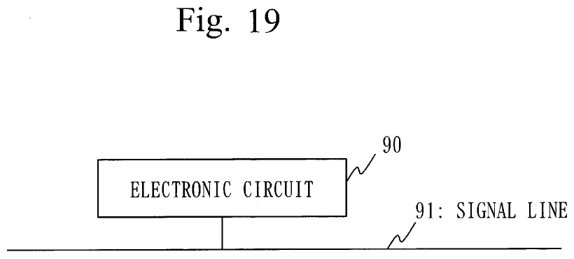

FIG. 19 illustrates a configuration in which the functions of the equipment selection assistance apparatus are realized by hardware. An electronic circuit 90 in FIG. 19 is a dedicated electronic circuit that realizes the functions of the operation record information collection unit 11, the operation model generation unit 12, the equipment selection processing unit 13, the user interface unit 14, the cluster model setting unit 15, the selection reference model setting unit 16, the other-system information acquisition unit 17, the condition acceptance unit 18, and the number-of-occupants information acquisition unit 19 of the equipment selection assistance apparatus.

The electronic circuit 90 is connected to a signal line 91. Specifically, the electronic circuit 90 is a single circuit, a composite circuit, a programmed processor, a parallel-programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of the components of the equipment selection assistance apparatus may be realized by one electronic circuit, or may be distributed among and realized by a plurality of electronic circuits. Some of the functions of the components of the equipment selection assistance apparatus may be realized by the electronic circuit, and the rest of the functions may be realized by software.

Each of the CPU and the electronic circuit 90 is also referred to as processing circuitry. The functions of the operation record information collection unit 11, the operation model generation unit 12, the equipment selection processing unit 13, the user interface unit 14, the cluster model setting unit 15, the selection reference model setting unit 16, the other-system information acquisition unit 17, the condition acceptance unit 18, and the number-of-occupants information acquisition unit 19 of the equipment selection assistance apparatus may be realized by the processing circuitry.

Note that each component of the monitoring system 10 described in the first to eighth embodiments corresponds to each means as indicated below.
(1) The operation record information collection unit 11 corresponds to an operation record information acquisition means.
(2) The operation model generation unit 12 corresponds to an operation model generation means.
(3) The equipment selection processing unit 13 corresponds to a selection processing means.
(4) The cluster model setting unit 15 corresponds to a cluster model setting means.
(5) The user interface unit 14 corresponds to the display means.
(6) The selection reference model setting unit 16 corresponds to a selection reference model setting means.
(7) The condition acceptance unit 18 corresponds to an acceptance means.
(8) The user interface unit 14 corresponds to an equipment information acquisition means.

### REFERENCE SIGNS LIST

1: network, 2: equipment, 3: entrance and exit management system, 10: monitoring system, 11: operation record information collection unit, 12: operation model generation unit, 13: equipment selection processing unit, 14: user interface (UI) unit, 15: cluster model setting unit, 16: selection reference model setting unit, 17: other-system information acquisition unit, 18: condition acceptance unit, 19: number-of-occupants information acquisition unit, 21: operation record information storage unit, 22: operation model storage unit, 23: cluster model storage unit, 24: selection reference model storage unit, 25: equipment information storage unit

1. An equipment selection assistance apparatus comprising:
processing circuitry to:
acquire operation record information indicating an operation record of each piece of equipment installed in a facility;
generate, for each piece of equipment, an operation model indicating an operating state of each piece of equipment in a predetermined period, based on the operation record information;
select control target equipment to be a target of demand control from pieces of equipment installed in the facility, based on generated operation models;
set a selection reference model to be compared with each generated operation model; and
automatically select the control target equipment, depending on a result of comparison between each generated operation model and the selection reference model.

2. The equipment selection assistance apparatus according to claim 1,
wherein the processing circuitry displays generated operation models, and
selects, as the control target equipment, equipment corresponding to an operation model selected by a user from the displayed operation models.

3. The equipment selection assistance apparatus according to claim 1,
wherein the processing circuitry sets, as a cluster model, an operation model corresponding to each cluster generated by classifying generated operation models according to similarities into a plurality of clusters,
displays cluster models that are set, and
selects, as the control target equipment, one or more pieces of equipment corresponding to an operation model included in a cluster model selected by the user from the displayed cluster models.

4. The equipment selection assistance apparatus according to claim 1,
wherein as a result of comparison between operation record information before and operation record information after the control target equipment that is selected is demand-controlled, when it is determined that a power reduction effect is obtained by selecting the control target equipment as the target of demand control, the processing circuitry sets a selection reference model used in selecting the control target equipment as a selection reference model for selecting next control target equipment.

5. The equipment selection assistance apparatus according to claim 1,
wherein the processing circuitry sets, as a selection reference model, a selection reference model used in selecting control target equipment with which a power reduction effect has been obtained in another facility.

6. The equipment selection assistance apparatus according to claim 1,
wherein the processing circuitry accepts a condition for comparison between an operation model and a selection reference model, and
selects control target equipment by comparing each operation model with the selection reference model in accordance with the condition for comparison.

7. The equipment selection assistance apparatus according to claim 1,
wherein the processing circuitry acquires equipment information in which pieces of equipment that operate in cooperation are associated with each other, and
when a plurality of pieces of control target equipment are selected, refers to the equipment information to identify pieces of equipment respectively associated with the plurality of pieces of control target equipment, assigns priorities to the plurality of pieces of control target equipment based on operation models of the identified pieces of equipment, and narrows down the plurality of pieces of control target equipment according to the priorities.

8. The equipment selection assistance apparatus according to claim 1,
wherein the processing circuitry sets a selection reference model based on a change in the number of occupants in the facility acquired from an entrance and exit management system.

9. The equipment selection assistance apparatus according to claim 1,
wherein the operational record of each piece of equipment is at least one of an operating time, surplus power, and power consumption.

10. A non-transitory computer readable medium storing a program for causing a computer to:
acquire operation record information indicating an operation record of each piece of equipment installed in a facility;
generate, for each piece of equipment, an operation model indicating an operating state of each piece of equipment in a predetermined period, based on the operation record information;
set a selection reference model to be compared with each generated operation model; and
select control target equipment to be a target of demand control from pieces of equipment installed in the facility, depending on a result of comparison between each generated operation model and the selection reference model.
